(19) United States
(12) Patent Application Publication
(10) Pub. No.: US 2004/0100708 A1
(43) Pub. Date: May 27, 2004

(54) Producing method of optical film

(76) Inventors: Yoshiaki Noda, Kanagawa (JP); Tatsuo Shiino, Kanagawa (JP); Kiyoshi Fukuzawa, Kanagawa (JP); Ryo Mori, Kanagawa (JP)

Correspondence Address: BIRCH STEWART KOLASCH & BIRCH, PO BOX 747, FALLS CHURCH, VA, 22040-0747, US

(21) Appl. No.: 10/702,556

(22) Filed: Nov. 7, 2003

(30) Foreign Application Priority Data
Nov. 8, 2002 (JP) 2002-325644

(51) Int. Cl. G02B 5/08; G02B 7/182

(52) U.S. Cl. 359/883

(57) ABSTRACT

When it is complete to unwind a first PVA film from a first film roll, it is started to unwind a second PVA film from a second film roll. A trailing end portion of the first and second PVA film and a leading end portion of the second PVA film are overlaid at a film connecting position. A receive stage and a seal head of a heat sealer sandwiches overlaid portions, and a head body of the seal head heats them so as to thermally melt and adhere the first and second PVA films. During the thermal melt-adhesion, a thermal melt-adhesion line is formed in the overlaid portions of the first and second PVA films.

### BACKGROUND OF THE INVENTION

1. Field of the Invention

The present invention relates to a producing method of an optical film.

2. Description Related to the Prior Art

The spread of a liquid crystal display (hereinafter LCD) rapidly increase the demand of a polarizing sheet. The polarizing sheet is constructed of a polarized film which usually has a polarization character, and a protective film which is adhered with an adhesive agent to one or each surface of the polarized film. As a main material of the polarized film, polyvinylalcohol (hereinafter PVA) is usually used. A PVA film formed of the PVA is expanded or stretched in one axial direction and thereafter dyed with a dichromatic dye or boron. Otherwise the PVA film is dyed and thereafter expanded. Further, the cross-linking on the PVA film is carried out with boron compounds to form the polarized film. Usually, the PVA film is expanded in a lengthwise direction as the one axial direction. Accordingly, the absorbing axis of the polarized film is almost parallel to the lengthwise direction. Sometimes the PVA film is expanded in a widthwise direction. In this case, a tentering device has clips which move asymmetrically between left and right sides. The clips hold and transport the PVA film.

In the LCD, transmission axes of the polarizing sheet is inclined at 45° to a perpendicular or vertical direction of a screen. Accordingly, in the blanking process, the blanking of a continuous polarizing sheet is made with inclination of 45° to a lengthwise of the continuous polarizing sheet. In this case, however, the both end portions of the continuous polarizing sheet cannot be used. Especially, when it is designate to obtain the large size of the blanked polarizing sheet, then the amount of the unusable part of the polarizing sheet becomes larger, and the productivity becomes lower. After the adhesion of the protective film, the materials of the unused part are hardly recycled. As the results, the amount of the waste increases.

Accordingly, Japanese Patent Laid-Open Publication No. 2002-86554 and the like propose a tentering device for producing a polarized film with inclination of the polarization axis to a film transporting direction of the polymer film. The tentering device has pairs of clips, and the clips in each pair asymmetrically move on clip passages in both sides of the tentering device. The clips expand and transport a polymer film, and the transported polymer film is tensed by the clips in a direction inclined to the film transporting direction.

The tentering device is disposed in a process after the film is formed in a melt-extrusion method or in a solution casting method, and used for continuously expanding the formed film. However, the tentering device is not only used for expanding the film just after the production thereof. But the film is often wound to a film roll at first after the production thereof, and the film is unwound from the film roll and supplied in the tentering device, in order to continuously supply the polymer film unwound from the film roll, it is necessary to connect the two continuous films between the previous film roll and the following film roll, when the length of the continuous polymer film in the previous film roll becomes small. However, in the prior art, the connecting of the two continuous polymer film is made by binding with hands, combining with an adhesive tape or the like. In these cases, the spliced or connected portion of the continuous polymer films has different thickness and rigidity from other portions. Accordingly, when the connected portion passes through the tentering device, wrinkles occur, the connected continuous films come away, or the continuous film is cut or broken. Especially, in equipments for producing a polarizing sheet, the processing of a cleaning, a dying, a hardening and the like are made for the continuous polymer film in the sheet form as a material of the polarizing sheet. After these processing, the film is expanded with the tentering device, and further the heating process of the film is made. Accordingly, when the content of water in the connected portion of the film becomes higher in the liquid treatment process, the polymer films come away in the connected portions, or the connected portions come away especially in the tentering device. Instead of the thermal melt-adhesion, the two PVA films may be adhered with a heat seal (or an adhesive agent.

### SUMMARY OF THE INVENTION

An object of the present invention is to provide a producing method of an optical film, in which connected polymer films does not come away in the liquid treatment process, the expanding process, and the heating process, and in which the film is not cut or broken in a film expanding system.

In order to achieve the object and the other object, in the producing method of the present invention, a first polymer film is unwound from a first film roll, and when the unwinding thereof is complete, the second polymer film is unwound. Parts of the first and second polymer films are overlaid at a film splicing or connecting position so as to thermally melt and adhere the first and second polymer films. The connected first and second polymer films are expanded with a tentering device disposed downstream from the film connecting position. Further, a loop of the first polymer film is formed between the film connecting position and the tentering device, and the loop of the first polymer film is continuously supplied into the tentering device during the thermal melt-adhesion. Note that instead of the thermal melt-adhesion, the polymer films may be adhered with a heat seal (an adhesive agent).

A trailing end of the first polymer film and a leading end of the second polymer film are overlaid, and part or entire of these overlaid ends are thermally melt and adhered so as to form thermal melt-adhered part in line. A line width of the line formed in the thermal melt-adhesion is 1-10 mm.

According to the present invention, when the length of the remaining first polymer film becomes small, a trailing end of the first polymer film and a leading end of the second polymer film are overlaid. Then these overlaid ends of the first and second polymer films is thermally melt-adhered. A line width of the thermal melt-adhered part is 1-10 mm. Accordingly, after the first and second polymer films are connected, they are not broken or cut in the processes of the liquid treating, the expanding and the drying in the film expanding system. Further, the length from the thermal melt-adhesion line to the front or rear end point of the first and second polymer films is at most 10 mm, preferably 0 mm. Thus the waste of the polymer film is reduced and the treatment nonuniformity is prevented.

### BRIEF DESCRIPTION OF THE DRAWINGS

The above objects and advantages of the present invention will become easily understood by one of ordinary skill in the art when the following detailed description would be read in connection with the accompanying drawings.

FIG. 1 is a plan view of a PVA film expanding system used in a producing method of an optical film in the present invention;

FIG. 2 is a diagrammatical view of a film supply device, illustrating a situation that the first PVA film is unwound;

FIG. 3 is a similar view of FIG. 2, illustrating a situation that the unwinding of the first PVA film is complete;

FIG. 4 is a similar view of FIGS. 2 and 3, illustrating a situation that the first PVA film and a second PVA film are connected;

FIG. 5 is a perspective view illustrating a positional relation of a heat sealer and the first and second PVA films;

FIG. 6A is a diagrammatical view of a first embodiment of the thermal melt-adhesion in the producing method of the present invention;

FIG. 6B is a partially exploded view of FIG. 6A;

FIG. 7A is a diagrammatical view of a diagrammatical view of another embodiment of the thermal melt-adhesion; and

FIG. 7B is a partially exploded view of FIG. 7A.

### PREFERRED EMBODIMENTS OF THE INVENTION

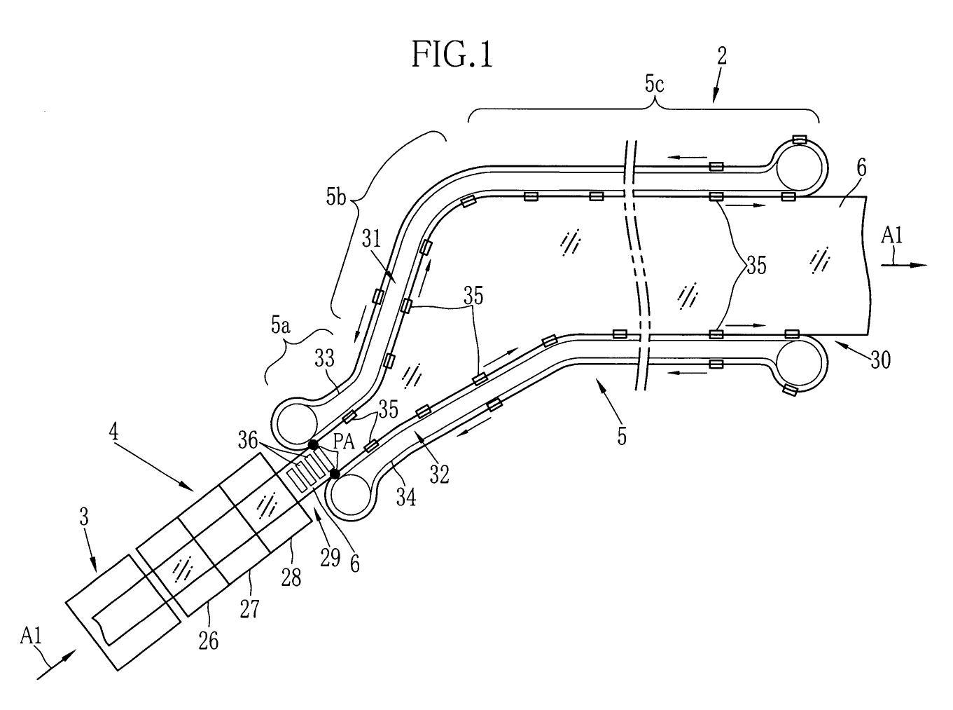

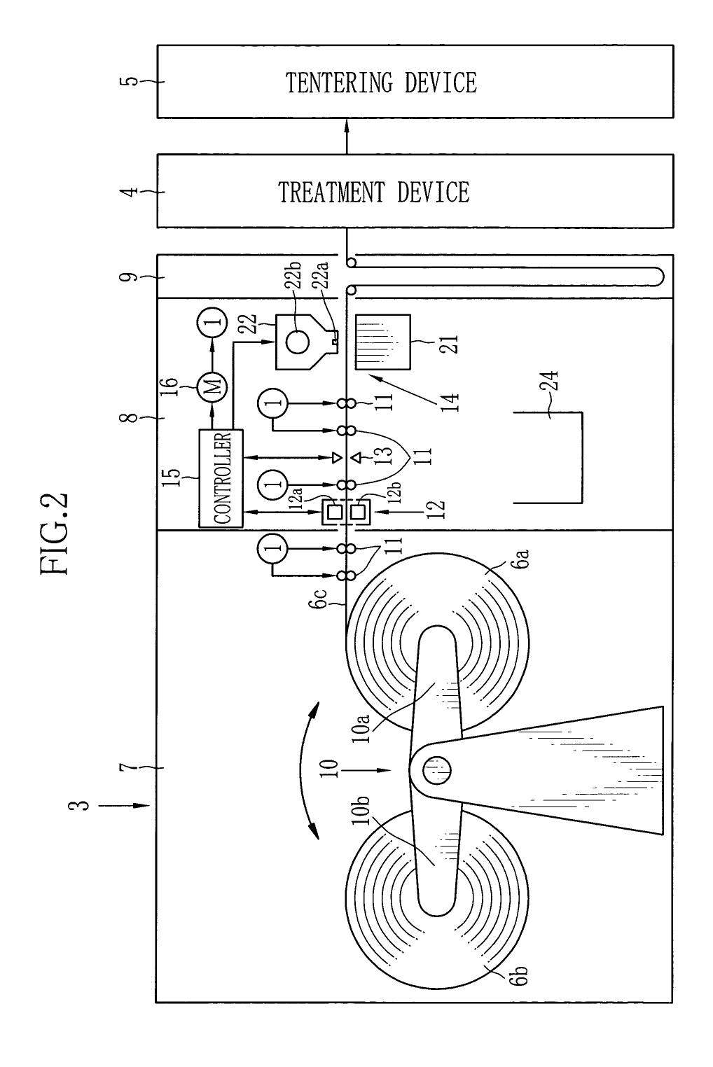

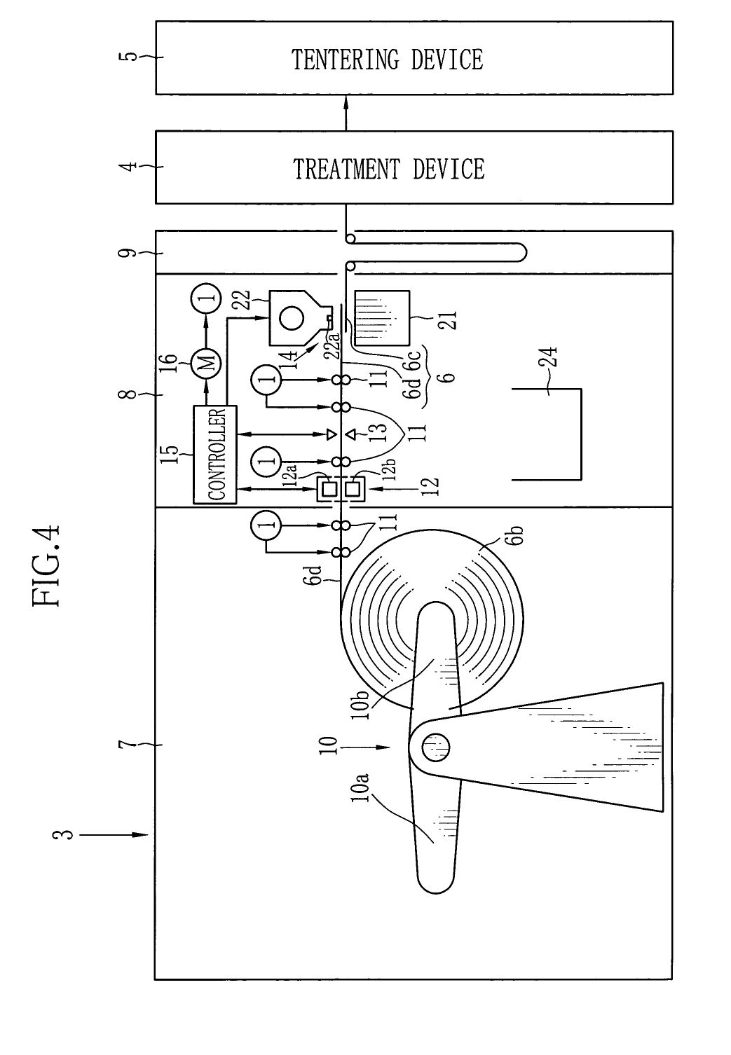

In FIG. 1, a PVA film expanding system 2 for expanding a PVA film (or polyvinylalcohol film) 6 is constructed of a film supply device 3, a treatment device 4 and a tenter or tentering device 5. As shown in FIG. 2, the film supply device 3 is constructed of a film containing section 7, a film connecting section 8 and a reservoir 9. In the film containing section 7 are contained first and second film rolls 6a, 6b, in which a first PVA film 6c and a second PVA film 6d (see, FIG. 4) are wound respectively. Note that the PVA film 6 (FIG. 1) is used as a general term of the first and second PVA films 6C, 6d.

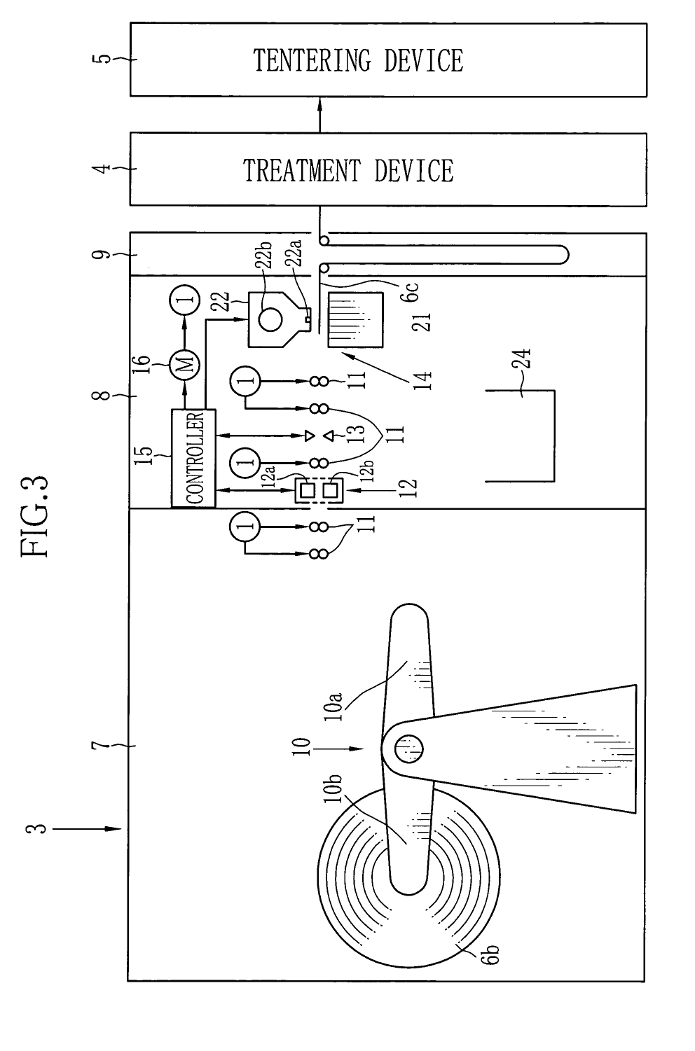

The film containing section 7 has a turret arm 10 for rotatably holding the first and second film rolls 6a, 6b. The turret arm 10 is provided with two attachment shafts 10a and 10b. While the first PVA film 6c in a film supply position is unwound and transported from the first film roll 6a attached to the attachment shaft 10a, then the second film roll 6b is set to the attachment arm 10b. As shown in FIG. 3, when the unwinding from the first film roll 6a is completed, the turret arm 10 rotates. And as shown in FIG. 4, the second film roll 6b is set to the film supply position. Then the second PVA film 6d is unwound and transported. Further, a roll core (not shown) is removed from the attachment shaft 10a, and a new film roll is set thereto. These processes are repeated such that the film rolls may be set to the supplying position sequentially. Thus the PVA film is continuously supplied.

The film connecting section 8 includes plural feed roller pairs 11, an edge sensor 12, a film cutter 13, a heat sealer 14 and a controller 15. The feed roller pairs 11 are disposed so as to form a feed path for the PVA film 6, and driven and rotated by a feed motor 16 so as to nip and transport the PVA film 6. The edge sensor 12 detects the passage of front and rear end points of the first and second PVA films 6c, 6d, and is constructed of a light projector 12a and a light receiver 12b. The film cutter 13 cuts the rear end point of the first PVA film 6c and the front end point of the second PVA film 6d, and a leading end portion of the first PVA film 6c and a trailing end portion of the second PVA films 6d will be overlaid as overlaid portions such that the first and second PVA films 6c, 6d may be easily connected.

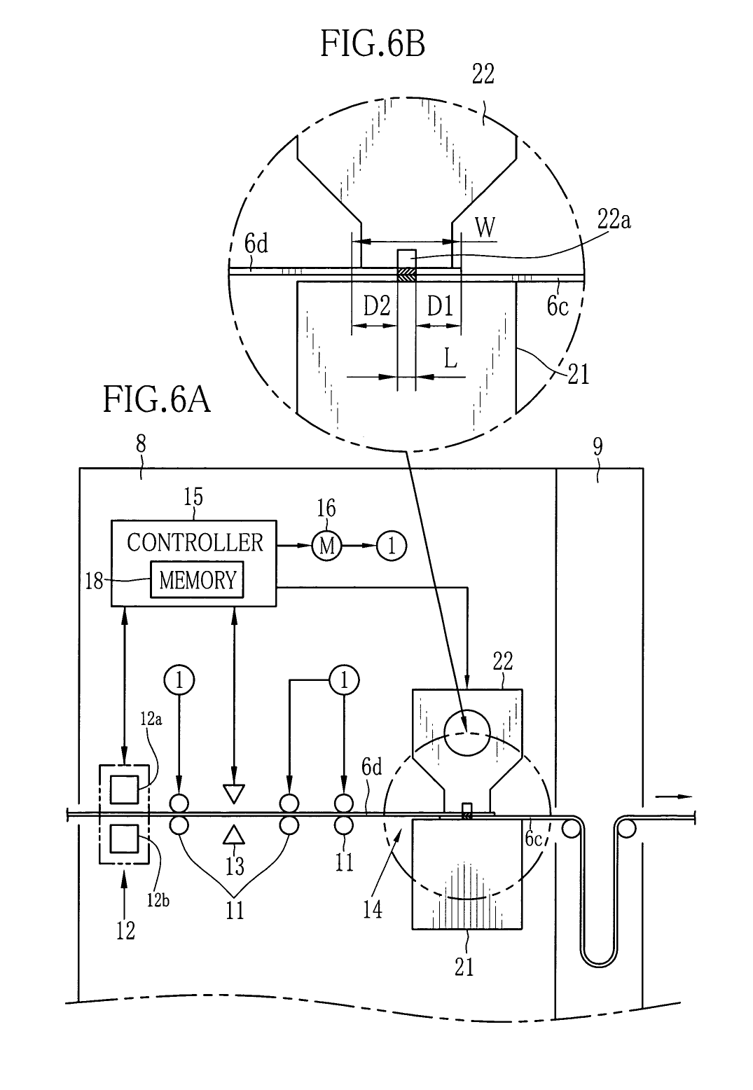

The heat sealer 14 is constructed of a seal stage 21 and a seal head 22. The seal head 22 is constructed of a head body 22a and a heater 22b, and the head body 22a is heated by the heater 22b. When the heat sealer 14 connects the first and second PVA films 6c, 6d, then the seal head 22 and the seal stage 21 move vertically to sandwich the overlaid portions of the first and second PVA films 6c, 6d. Thereafter, the head body 22a heats and adheres the overlaid portions to form a thermal melt-adhesion line L being 2 mm wide (see, FIG. 6B), such that the first and second PVA films 6c, 6d are connected. Accordingly, the size of the head body 22a in the film transporting direction A1 is 2 mm. The seal stage 21 and the seal head 22 extend in a widthwise direction of the film so as to thermally melt and adhere the first and second PVA films 6c, 6d over the entire width of them.

The controller 15 controls the film connecting section 8, the film containing section 7 and the reservoir 9, so as to supply the PVA film 6 at a constant speed for the treatment device 4. And the controller 15 continuously supplies the second PVA film 6d after the supply of the first PVA film 6c. Then the trailing end portion of the first PVA film 6c and the leading end portion of the second PVA film 6d are spliced or connected. When the edge sensor 12 detects the edge of the PVA film 6, the predetermined length of the PVA film 6 is transported, and thereafter the controller 15 stops transporting the film so as to make a positioning of the end portion of the PVA film 6 to the film cutter 13. Then the leading end portion is cut off in a perpendicular direction to the film transporting direction A1, so as to easily connect the first and second PVA films 6c, 6d. Thus the end treatment is made. The removed end portion is guided by a branching guide (not shown) and recovered into a trash box 24. Thereafter, the feed roller pairs 11 transport the first PVA film 6c in the film supply device 3, and through the reservoir 9 to the treatment device 4 and a tentering device 5. In the reservoir 9, a loop of the PVA film 6 is formed, whose length is more than that necessary for the time of connecting the film (mentioned below), and thereafter the PVA film 6 is fed out to the treatment device 4.

As shown in FIG. 1, the treatment device is provided with a washing or cleaning bath 26, a dying bath 27 and a hardening bath 28 from the upstream in the film transporting direction A1. The cleaning bath 26, the dying bath 27 and the hardening bath 28 contain respectively predetermined amount of a cleaning agent, an aqueous solution of a dying agent (iodine and the like), and an aqueous solution of hardening agent (such as boric acid). When the PVA film transported from the film supply device 3 into the treatment device 4, then transferring devices (not shown) sequentially transport through the baths 26-28 so as to perform treatments of the cleaning, the dying, and the hardening. The PVA film 6 after sequential treatment in baths 26-28 is wet and transported to the tentering device in this situation. Note that the treatment device 4 is constructed of three baths (the cleaning bath 26, the dying bath 27 and the hardening bath 28) in this embodiment. However, other baths may be added if necessary. Further, the dying bath and the hardening bath may be synthesized to one bath such that the number of the baths may be smaller.

The tentering device 5 is constructed of a left rail 31, right rail 32 and endless chains 33, 34 which are guided by the rails 31, 32. To the endless chains 33, 34, large number of clips 35 are attached as holding members at a predetermined pitch. The clip 35 holds both selvedges or side edge portions of the PVA film 6, and moves in the rails 31, 32 by the drive of the driving mechanism (not shown), so as to expand the PVA film 6.

The tentering device 5 is constructed of a preheat section 5a, an expanding section 5b and a heat processing section 5c. The temperatures and the humidities of the preheat section 5a and the expanding section 5b are kept high, so as to easily expand the PVA film 6. In the tentering device 5, the left tail 31 and the right rail 32 are curved or bent so as to have different forms. Accordingly, the PVA film 6 is expanded in a direction inclined to the lengthwise direction, so as to become optical polymer film having inclined polarization axes.

Effects of the above embodiment of the present invention will be described now. The first PVA film 6c, after transported in the film supply device 3 by the feed roller pairs 11, is fed to the cleaning bath 26 in the treatment device 4. As shown in FIG. 3, when the entirety of the first PVA film 6c by the first film roll 6a is unwound, then the edge sensor 12 detects the rear end point of the first PVA, film 6c, and thereafter the feed motor 16 is driven for a predetermined time so as to make the positioning of the rear end point of the first PVA film 6c to the film cutter 13. The film cutter 13 cuts off the trailing end portion of the first PVA film 6c in the widthwise direction in order to easily connect the trailing end portion of the first PVA film 6c. Thus the end treatment is made. After the end treatment, the predetermined length of the first PVA film 6c is transported and positioned to the film connecting position. Thereby as the first PVA film 6c in the reservoir 9 is transported to the treatment device 4, the treatment device 4 and the tentering device 5 are not stopped. The trailing end portion cut off from the first PVA film 6c is guided by the branching guide (not shown) to the trash box 24 disposed below. Note that the first PVA film 6c is bent and damaged where it contacts to the trailing end portion on the roll core. Accordingly, the length of the trailing end portion of the first PVA film that is cut off by the film cutter 13 in the cutting process is preferably 600 mm which is twice as large as the circumference of the roll core, as the diameter of the roll core is 3 inches (76.2 mm). However, the length is not restricted in it and may be changed.

After the positioning of the first PVA film 6c to the film connecting position, the turret arm 10 rotates and the second film roll 6b is set to the film supplying position. Thus the second PVA film 6d is supplied. As shown in FIG. 4, the front end point of the second PVA film 6d supplied from the second film roll 6b is detected by the edge sensor 12, and the feed motor 16 is driven for a predetermined time. Thus the leading end portion of the second PVA film 6d is set to the film cutter 13. The film cutter 13 cuts off the leading end portion of the second PVA film 6d in the widthwise direction. Thus the end treatment is made. Thereafter, a predetermined length of the second PVA film 6d is transported and the positioning of the second PVA film 6d to the film connecting position is made. Thereby, as the first PVA film 6c in the reservoir 9 is supplied for the treatment device 4, the positioning of the second PVA film 6d is made without stopping the treatment device 4 and the tentering device 5. The leading end portion cut off from the second PVA film 6d is guided by the branching guide to the trash box 24. Note that the leading end portion of the second PVA film is damaged from the outside or the circumstances. Accordingly, the length of the leading end portion cut off by the film cutter 13 in the cutting process is preferably 1500 mm which is as large as the circumference of the surface. Naturally, the length is not restricted in it and may be changed adequately.

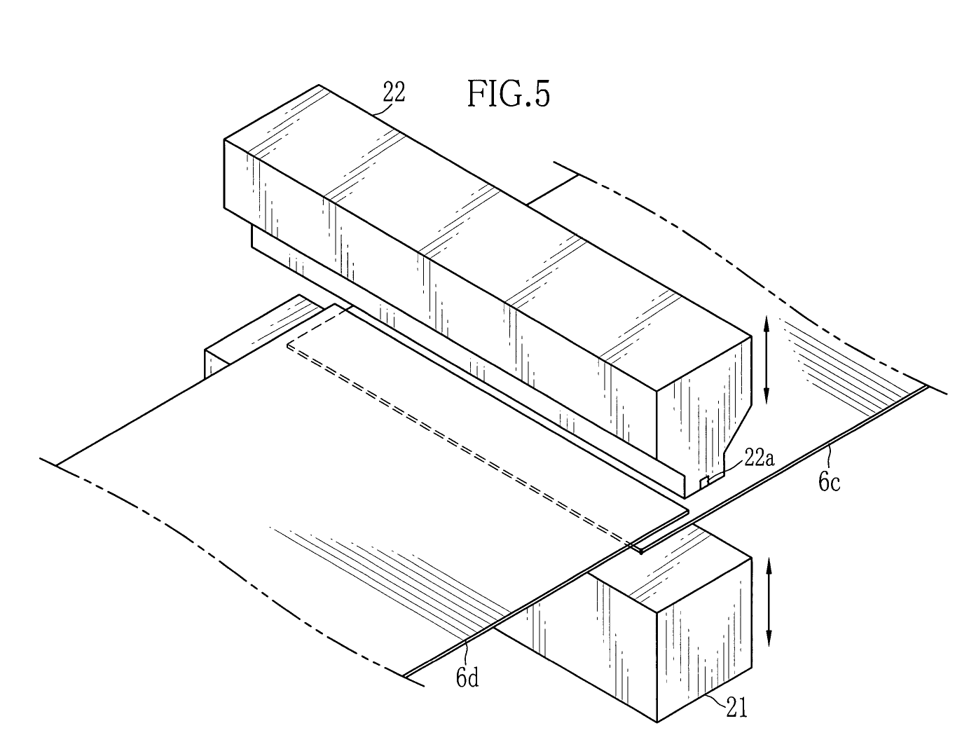

As shown in FIG. 5, the positioning of the first and second PVA film 6c, 6d is made. When the positioning is complete, as shown in FIGS. 6A and 6B, the width W of the overlaid portion (or the distance between the rear end point of the first PVA film 6c and the front end point of the second PVA film 6d) is 12 mm. Then the controller 15 actuates the heat sealer 14 such that the head body 22a of the seal head 22 may contact to a central area of the overlaid portion. Then the heat body 22a heats to melt and adhere the first and second PVA films 6c, 6d, and the thermal melt-adhesion line L with a width of 2 mm is formed. Therefore, the distance D1, D2 from the end point of each first and second PVA film 6c, 6d to the thermal melt-adhesion line L is 5 mm. Thereby as the first PVA film in the reservoir 9 is supplied in the treatment device 4, the first and second PVA films 6c, 6d are thermally melt and adhered without stopping the treatment device 4 and the tentering device 5.

The contact surface of the head body 22a to the film has the temperature from 100 to 300° C., preferably 150 to 250° C. When the first and the second PVA films are thermally melt and adhered, the heat sealer 14 presses the films the pressure from 1 to 10 KPa for from 0.5 to 5 seconds. Thus in the treatment device 4 and the tentering device 5, it is reliable that the first and second PVA films 6a, 6b do not accidentally peel from each other at the thermal melt-adhesion line L.

A memory 18 in the controller 15 stores a first time data and a second time data. The first time data is the data of the time from the passage of the rear end point of the first PVA film 6c at the edge sensor 12 to its setting in a position for forming the overlaid portion having the width W of 12 mm. The second time data is the data of the time from the passage of the front end point of the second PVA film 6d at the edge sensor 12 to its setting in a position for forming the overlaid portion having the width W of 12 mm. Based on the first and second time data, the controller 15 drives and controls the feed motor 16 so as to rotate and stop the feed roller pairs 11.

In the above description, as the first and second PVA films are thermally melt and adhered on one line in the widthwise direction of the film with the heat sealer 14 to form the thermal melt-adhesion line L of 2 mm, the treatment liquid can be penetrated to inner side of the thermal melt-adhesion line L in the treatment device 4. And the PVA film 6 is expanded in the tentering device without break of the adhered portion.

The PVA film 6 supplied from the film supply device 3 in the cleaning bath 26, the dying bath 27 and the hardening bath 28. Thus the treatments of cleaning, dying and hardening are made. After treatment in each bath 26-28, the PVA film 6 is transported to the tentering device 5.

The PVA film 6 fed to the tentering device 5 is transported to the film holding position PA by feed rollers 36. The both side edge portions of the PVA film 6 are held by the clip 35. While the clips 35 hold the side edge portions of the PVA films, the clips 35 moves in the rails 31, 32 by the driving mechanism so as to expand the PVA film 6. The temperature and the humidity of the preheat section 5a and the expanding section 5b is kept high in order to easily expanded the PVA film 6. Near to an exit 30 of the tentering device 5, the clip 35 releases the PVA film 6 after the expanding, and the PVA film 6 is discharged from the exit 30. Note that an entrance 29 of the tentering device 5 may be provided with a nip roller pair for tensing the PVA film 6 in the widthwise direction. There may be a guide roller in upside before the film holding position PA for restraining the upward deformation of the PVA film 6. Further, a film guide may be provided from the entrance 29 to the film holding position PA for guiding the both ends of the PVA film 6.

The PVA film 6 discharged from the exit 30 has inclined orientation by expanding obliquely, and it is adequate for the polarized film. When a TAC film (or triacetylcellulose film) is attached to the polarized film, the polarizing sheet is produced. It is preferable that the PVA film may be expanded with angle of 45°.

Note that in the above embodiment, the thermal melt-adhesion line L of the first and second PVA film 6c, 6d is 2 mm wide, and the width of the overlaid portion of the first and second PVA films 6c, 6d is 12 mm. However, the present invention is not restricted in it. The thermal melt-adhesion line L may have a width in the range of 1 to 10 mm, and the width of the overlaid portion may be changed such that the distances D1, D2 from the thermal melt-adhesion line L to the film edges are at most 10 mm.

Further, in the above embodiment is used the heat sealer 14 as a connecting means for the first PVA film 6c and the second PVA film 6d. As the connecting means, there are further an impulse seal and several sorts of the connecting means of a type in which thermal melt-adhesion or welding is made.

Further, in the above embodiment, the turret arm 10 rotates so as to automatically set the film rolls 6a, 6b to the film supply position. However, the setting of the new film roll to the turret arm 10 may be made manually with human hands.

In the above embodiment, the first time data and the second time data are previously stored in the memory 18, depending on the transporting speed of the film. Based on the first and second time data, the controller 15 drives and controls the feed motor 16 so as to rotate and stop the feed roller pairs 11. However, the present invention is not restricted in this structure. The positioning of the first and second PVA films 6d, 6d may be made mechanically by using the positioning member.

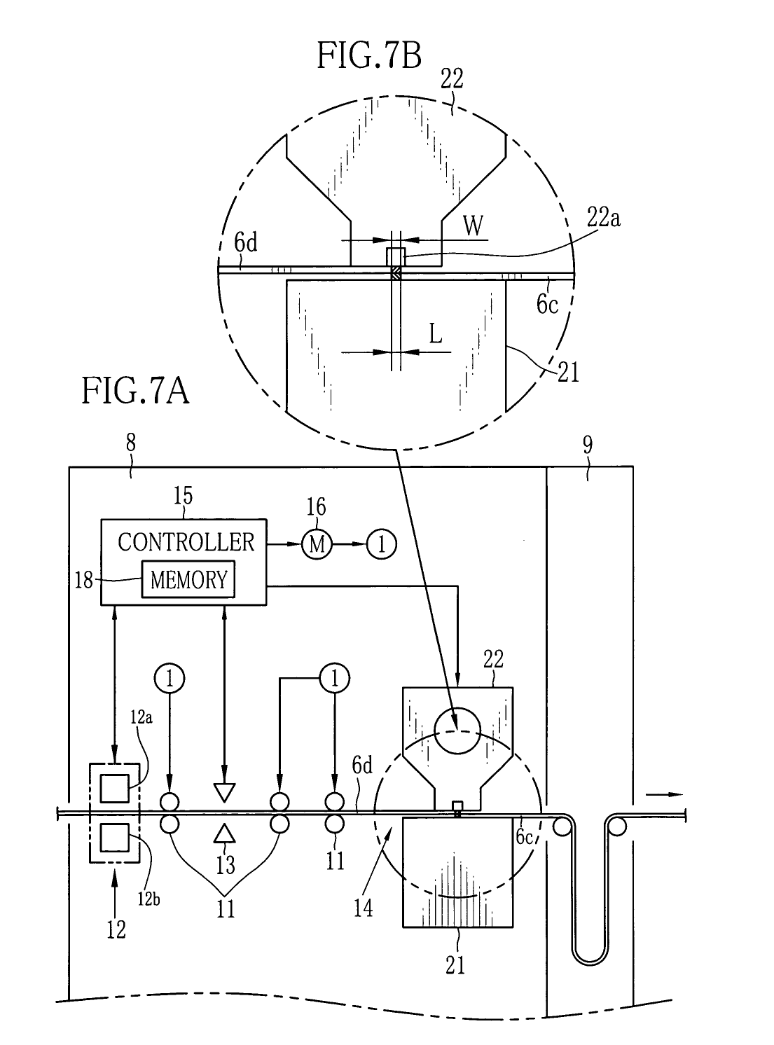

FIGS. 7A and 7B illustrate another embodiment of the present invention, and the same elements or members have the same numerals as in the above embodiment. In this figure, the overlapped portion of each first and second PVA film 6c, 6d has the width W of 1 mm, and the line width L of the thermal melt-adhesion line L of each first and second PVA film 6c, 6d is 1 mm. The width of the overlapped portion is smaller than the width of the head body 22a that is 2 mm, and thus the distances D1, D2 from the thermal melt-adhesion line to the film edges is 0 mm. Accordingly, waste of the film is prevented. As the lengths D1, D2 are 0 mm, there is no openness between overlapped portions. If there is openness between the overlapped portions, the treatment liquid enters in the openness between the first and second PVA films 6c, 6d, which causes the nonuniformity of the treatment. However, in the embodiment, as there is no openness, the nonuniformity of the treatment is prevented.

In FIG. 1, the difference of the speed of the moving clips 35 between the left and right rails 31, 32 at the exit 30 of the tentering device 5 causes the generation of wrinkles and creases. Therefore, it is necessary that there is substantially no difference of the speed of the moving clips 35 between the left and right rails 31, 32. The difference is preferably at most 1%, particularly less than 0.5%, especially less than 0.05%. The speed is determined as the length of a locus where the clip moves in one minute on the left or right rail 31, 32. In the usual tentering device and the like, the speed of the moving clips fluctuates at a certain period shorter than one second, depending on the period of sprocket tooth for driving a chain and the frequency of the drive motor. Fluctuation at a ratio of a number of hundredths may occur in the speed. However, the difference of the speed is not that of the speed of the moving clips in the present invention.

The PVA film 6 expanded by the PVA film expanding system 2 can be used as the polarized film having excellent characteristics of polarization. The protective film is adhered to one or both of surfaces of the PVA film 6 as the polarized film with an adhesive layer of an adhesive agent. Thus the polarizing sheet is obtained, and excellent in transmittance of single plate and degree of polarization. Accordingly, when the polarizing sheet is used in the liquid crystal display, then the contrast of the image can become higher and therefore the quality of the liquid crystal display is high.

The degree of saponification of polyvinyl alcohol is not restricted especially. However, in view of solubility, the degree of saponification is preferably 80-100 mol %, particularly 90-100 mol %. The degree of polymerization of polyvinyl alcohol is not restricted. However, it is preferably 1000-10000, particularly 1500-5000.

The modulus of elasticity of the PVA film 6 before the expanding is preferably at least 0.01 MPa and at most 5000 MPa, and particularly at least 0.1 MPa and at most 500 MPa in Young's modulus. If the modulus of elasticity is too low, shrinkage percentage of the film after expanding becomes low, and therefore the wrinkle hardly disappears. If the modulus of elasticity is too high, the tension in the expanding becomes large, and therefore it is necessary that the side edge portion of the PVA film that is clipped by the clips 35 has larger intensity. Further, the load to the tentering device 5 becomes larger.

The thickness of the PVA film before the expanding is not restricted especially. However, it is preferably 1 μm-1 mm, particularly 20-200 μm, in view of the stability of holding the film and the uniformity of the expanding.

As the dying agent used in the present invention, there are I₃⁻, I₅⁻, or other polyiodinated ion dye, and/or organic dichromatic dye. As the dichromatic dye, there are dye compounds, concretely such as azo dyes, stilbene dyes, pyrazolone dyes, triphenylmethane dyes, quinoline dyes, oxazine dyes, thiazine dyes, anthraquinone dyes and the like. Preferably, they are soluble to the water. However, they are not restricted in it. Further, molecule having dichromatic property may have hydrophilic group, such as sulfonic acid group, amino group, hydroxyl group. As the molecule having dichromatic property, there are concretely, for example, CI Direct Yellow 12, CI Direct Orange 39, CI Direct Orange 72, CI Direct Red 39, CI Direct Red 79, CI Direct Red 81, CI Direct Red 83, CI Direct Red 89, CI Direct Violet 48, CI Direct Blue 67, CI Direct Blue 90, CI Direct Green 59, CI Acid Red 37 and the like. Furthermore, the dyes which contain molecule having dichromatic property is disclosed in Japanese Patent Laid-Open Publications S62-70802, H01-161202, H01-172906, H01-172907, H01-183602, H01-248105, H01-265205 and H07-261024. These molecules having dichromatic property are used as free acids, alkali metal salts, ammonium salts, salt form of amines. At least two sorts of molecule having dichromatic property may be mixed to produce polarizers having several sorts of color phase. In view of the excellence in optical transmittance of transparency of single plate and degree of polarization, the preferable compounds are one or mixture of the several sorts of molecule having dichromatic property, such that the screen of the polarizing sheet may turn in black when the absorptive axes of the polarizing sheets are rectangular. The polyiodinated ion I₃⁻, I₅⁻ (generating in iodine-potassium iodinate) are especially used for the film expanded by the PVA film expanding system 2 in the present invention.

When polyiodinated ion dyes (such as I₃⁻, I₅⁻ or the like that generate in iodine-potassium iodinate) are used for the polarizer, the content of iodine is 0.1-20 g/l and the content of potassium iodine is 1-200 g/l. The ratio of mass of the iodine to the potassium iodinate is preferably 1-200. The time for dying is preferably 10-5000 seconds, and the temperature of liquid for dying is 5-60° C.

As the hardening agent (cross-linking agent), the U.S. reissued Pat. No. 23297 discloses that it is preferable to use boric acid or borax in practice. Thereby, metal salt (such as zinc salts, cobalt salts, zirconium salts, iron salts, nickel salts, manganese salts and the like) can be further used.

Furthermore, the speed of tensing the PVA film 6 is at least 1.1 times per minute, preferably at least 2 times per minute, which are represented the magnification of expanding per unit time, and preferably can be considerably high. The moving speed in the lengthwise direction is at least 0.1 m/minute, preferably at least 1 m/minute, and preferably can be considerably high in view of productivity. In any case, the upper limits of them are different and depend on the tentering device 5 and the PVA film 6 to be expanded.

In the PVA film expanding system 2, when the both side edge portions of the PVA film 6 is held by the clips 35, it is preferable that the PVA film 6 is tensed such that the clips 35 may easily hold the PVA film 6. Concretely, the tension force is applied in the lengthwise direction of the PVA film, in order to tense it. The temperature of circumstance in the expanding is preferably 25-90° C., particularly 40-90° C.

The expanding is preferably made while the humidity of the atmosphere is adjusted. The humidity in the expanding is particularly preferably at least 50% and at most 100%, especially at least 80% and at most 100%.

Several sorts of functional films can be adhered to one or both of surfaces of the polarized film obtained in the PVA film expanding system 2 in the present invention. As the functional film, there are a birefringence film (such as λ/4 film, λ/2 film and the like), a light diffusing film, a plastic cell in which a conductive layer is provided on an opposite surface to the polarized film, a brightness enhancement film having isotropic scattering properties and anisotropic optical interference function and the like, a reflection film, and the reflection film having a medium transmittance.

As the protective film, the preferable one of the above protective films is used, or the several sorts of them are overlaid. The protective films adhered to both surfaces of the polarized film may be the same, and otherwise may have different characters or functions and physical properties. Further, when the protective film is adhered to the one surface, the another protective film is not adhered, but the adhesive layer is provided on another surface for directly adhering a liquid crystal cell. In this case, the separable film which can be peeled is preferably provided on the outside of the adhesive agent.

Many of the PVA films 6 which are expanded in the PVA film expanding system 2 in the present invention have the small thickness. In order to prevent troubles, for example the break of the PVA film, it is preferable that the protective film is adhered to at least one of the surfaces of the PVA film after the expanding process and thereafter the PVA film is heated in a heating process. As the concrete method for adhering, the protective film is adhered to the surface of the PVA film 6 with adhesive agent in the situation that both side edge portions of the PVA film are held. Thereafter, the both side edge portions are cut off with a usual cutting means, such as cutter, laser beam and the like. After adhesion, in order to dry the adhesive agent and to improve the characters of polarization, it is preferable to heat the PVA film. The conditions of the heating depend on the types of the adhesive agents. When the adhesive agent is water type, the temperature is at least 30° C., particularly at least 40° C. and at most 100° C., especially at least 50° C. and at most 80° C. Preferably, these processes are performed sequentially in a film production line for high quality and high productivity. Note that in the above embodiment both side edge portions of the PVA film are cut off in the tentering device 5 after adhesion of the protective film to the PVA film 6. However, the adhesion of the protective film may be made after the PVA film 6 is fed out from the tentering device 5, and thereafter the both side edge portions can be cut off.

Various changes and modifications are possible in the present invention and may be understood to be within the present invention.

What is claimed is:

1. A producing method of an optical film, said optical film being produced by expanding a polymer film with a tentering device, said producing method comprising steps of:
unwinding a first polymer film from a first film roll to supply said first polymer film to said tentering device;
unwinding a second polymer film from a second film roll after the unwinding of said first polymer film is completed;
overlaying a trailing end portion of said first polymer film and a leading end portion of said second polymer film at a film connecting position;
thermally melting and adhering part or entirety of said overlaid trailing and leading end portions in line; and
unwinding said second polymer film from said second film roll after the thermal melt-adhesion to supply said second polymer film into said tentering device.

2. A producing method as claimed in claim 1, further comprising steps of:
forming a loop of said first polymer film in a reservoir disposed between said film connecting position and said tentering device;
stopping said trailing end portion of said first polymer film when said trailing end portion of said first polymer film reaches the film connecting position; and
stopping said leading end portion of said second polymer film for the thermal melt-adhesion when said leading end portion of said second polymer film overlies on said trailing end portion of said first polymer film.

3. A producing method as claimed in claim 2, further comprising cutting off an old trailing end portion to form said trailing end portion, and/or cutting off an old leading end portion to form said leading end portion, with a cutter disposed upstream from the film connecting position.

4. A producing method as claimed in claim 3, wherein a line width of a thermal melt-adhesion line is in a range of 1-10 mm.

5. A producing method as claimed in claim 4, wherein a distance from said thermal melt-adhesion line to an end point of said trailing end portion of said first polymer film or an end point of said leading end portion of said second polymer film is at most 10 mm.

6. A producing method as claimed in claim 5, wherein said distance is 0 mm.

7. A producing method as claimed in claim 6, wherein a length of said old trailing end portion which is cut off is nearly twice as large as that of a circumference of a roll core of said first film roll.

8. A producing method as claimed in claim 7, wherein a length of said old trailing end portion which is cut off is nearly equal to that of a circumference of said second film roll.

9. A producing method as claimed in claim 1, wherein said thermal melt-adhesion is performed with a heat seal or an impulse seal.

10. A producing method as claimed in claim 3, wherein said first and second polymer films are a PVA film.

11. A producing method as claimed in claim 10, wherein said tentering device expands said first and second polymer films in a direction inclined relative to a film transporting direction.

12. A producing method as claimed in claim 11, wherein said first and second polymer films are treated with a treatment liquid shortly before entrance into said tentering device.
